(19) United States
(12) Patent Application Publication
(10) Pub. No.: US 2013/0244602 A1
(43) Pub. Date: Sep. 19, 2013

(54) MULTISTAGE RECEIVER SYSTEM

(71) Applicants: Derek Hagen, Ytterby (SE); Vimar Bjork, Goteborg (SE); Claes Rolen, Uddevalla (SE)

(72) Inventors: Derek Hagen, Ytterby (SE); Vimar Bjork, Goteborg (SE); Claes Rolen, Uddevalla (SE)

(73) Assignee: TELEFONAKTIEBOLAGET L M ERICSSON (PUBL), Stockholm (SE)

(21) Appl. No.: 13/988,084

(22) PCT Filed: Nov. 17, 2010
(86) PCT No.: PCT/EP2010/067670

§ 371 Date: May 17, 2013

(51) Int. Cl. H04B 1/10

(52) U.S. Cl. CPC H04B 1/10
USPC 455/226.1

(57) ABSTRACT

A receiver system with controllable attenuators and a component with a limited input range, arranged to receive as its input signal the output signal from the attenuators. The receiver system also comprises a compensation circuit which varies the level of the output signal of the component and a control loop which monitors the component and controls at least one attenuator to be active or inactive so that the level of the signal to the component is within the input range, and controls the compensation circuit to keep the output signal of the component constant. The control of the compensation circuit and attenuators between the component and said at least one attenuator is carried out in synchronicity with the propagation of the received signal through the attenuator chain from said at least one attenuator.

### TECHNICAL FIELD

The present invention discloses a multistage receiver system with reduced switching noise.

### BACKGROUND

For radio receivers with more than one processing stage for received signals, a so called receiver chain, it is important to control the dynamic range of the received signals at each stage in the receiver chain. One common feature in a high performance receiver chain is a function for automatic gain control, AGC, which is used in order to control the gain in the receiver chain so that the received signal does not saturate any of the stages in the receiver chain. In some receiver chain designs, use is made of a so called multi stage AGC solution, i.e. there is more more than one component for AGC in the receiver chain, by means of which the noise and dynamic range performance can be improved upon in the receiver design.

Altering the gain at any stage in the receiver chain during the reception of a continuous signal will add discontinuities to the received signal. When the received signal is then processed in subsequent stages of the receiver chain or in a demodulator in a radio unit in which the receiver chain is comprised, the discontinuities will add noise to the signal and will also widen the spectrum of the received signal. The more that a received signal is “corrupted” in this manner, the more probable it is that there will be errors in the demodulation process, which may ruin the interpretation of the received signal.

### SUMMARY

It is a purpose of the invention to obtain a receiver chain with improved gain control of a received signal and which obviates or eliminates at least some of the disadvantages of previously known receiver chains.

This purpose is addressed by the present invention in that it discloses a receiver system which comprises an attenuator chain with at least two attenuators which are coupled in cascade and which are arranged to attenuate a signal received by the receiver system.

The attenuating function of one or more of the attenuators in the attenuator chain is controllable to be active or inactive, and the receiver system also comprises a first component with a limited dynamic input range, and which is arranged to receive as its input signal the output signal from the attenuator chain.

In addition, the receiver system also comprises a controllable compensation circuit which is arranged to vary the level of the output signal of the first component, as well as comprising a control loop which is arranged to monitor the first component with respect to the level of its input signal and to control at least one of the attenuators to be active or inactive so that the level of the input signal from the attenuator chain to the first component is within the dynamic input range of the first component.

The control loop is also arranged to control the compensation circuit to keep the level of the output signal of the first circuit constant, and the control of the compensation circuit and of any attenuators which are arranged between the first component and the at least one attenuator is carried out in synchronicity with the propagation of the received signal through the attenuator chain from the at least one attenuator.

Thus, since the control of the compensation circuit and of any attenuators which are arranged between the first component and the at least one attenuator is carried out in synchronicity with the propagation of the received signal through the attenuator chain from the at least one attenuator, the switching transients can be minimized, since the switching is done as the signal propagates to, i.e. reaches, each attenuator.

Examples of the first component with a limited dynamic input range are such components as analogue to digital converters, amplifiers or limiters, i.e. limiting amplifiers.

In some embodiments, the receiver system comprises one or more additional components which each has its propagation delay time and which are arranged in or in connection to the attenuator chain. In those embodiments, the control loop is arranged to take the propagation delay time of the one or more additional components into account in the control of the compensation circuit and of any attenuators which are arranged between the first component and the at least one attenuator. In some such embodiments, the one or more additional components also have a limited dynamic input range, in which case the control loop is arranged to control one or more of the attenuators to be active or inactive in synchronicity with the propagation of the received signal from the at least one attenuator, so that the signal in or from the attenuator chain to the one or more additional components is within the dynamic input range of the one or more additional components.

In some embodiments of the receiver system, the control loop comprises a measuring circuit for obtaining measurement values of the output power of the receiver system as well as comprising a control circuit which is arranged to receive measurement values from the measuring circuit and for determining which attenuator or attenuators to activate or deactivate in order to keep the signal from the attenuator chain to the first component within the dynamic range of the first component as well as for controlling the compensation circuit to keep the output power of the receiver system constant.

In some embodiments of the receiver system, the controllable compensation circuit is arranged to vary the level of the output signal from the first component by means of a control signal to the first component.

In some embodiments of the receiver system, the controllable compensation circuit is arranged to vary the level of the output signal from the first component by means of receiving the output signal of the first component as its input signal, and to vary said level by means of a control signal form the control loop.

The invention also discloses a method for use in a receiver system, which comprises arranging a chain of at least two attenuators which are controllable with respect to their attenuation function at the input to a first component which has a limited dynamic input range. The method also comprises monitoring the input signal to the first component and determining at least one of said attenuators which should be controlled to be active or inactive in order to keep the input signal to the first component within its limited dynamic input range. In addition, the method also comprises controlling the level of the output signal from the first component to be constant, as well as comprising controlling the level of the output signal from the first component and any attenuators which are arranged between the at least one attenuator and the first component in synchronicity with the propagation of the signal from said at least one attenuator.

### BRIEF DESCRIPTION OF THE DRAWINGS

The invention will be described in more detail in the following, with reference to the appended drawings, in which

FIG. 1 shows a schematic block diagram of a first embodiment of the invention, and

FIG. 2 shows a schematic block diagram of a second embodiment of the invention, and

FIG. 3 shows a schematic flow chart for use in embodiments of the invention, and

FIGS. 4 and 5 show examples of embodiments for use in a receiver system, and

FIGS. 6 and 7 show diagrams of results obtained with and without the invention, and

FIG. 8 shows a schematic flow chart of a method of the invention.

### DETAILED DESCRIPTION

Embodiments of the present invention will be described more fully hereinafter with reference to the accompanying drawings, in which embodiments of the invention are shown. The invention may, however, be embodied in many different forms and should not be construed as being limited to the embodiments set forth herein by way of example. Like numbers in the drawings refer to like elements throughout.

The terminology used herein is for the purpose of describing particular embodiments only, and is not intended to limit the invention.

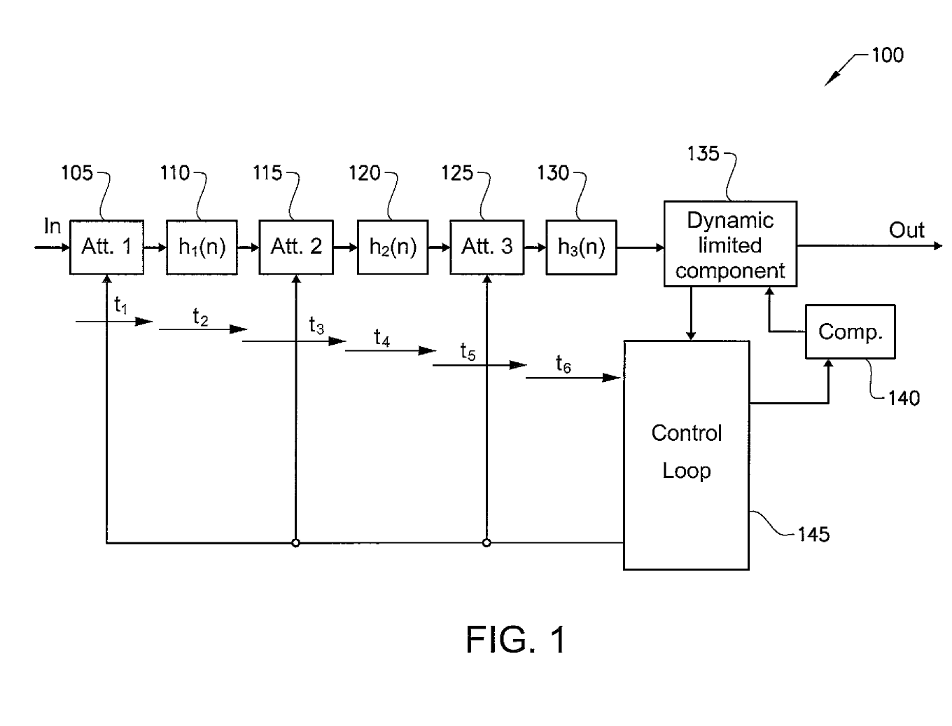

FIG. 1 shows a first embodiment of a receiver system 100. The receiver system 100 comprises an attenuator chain in which there are three cascade coupled attenuators, shown as 105, 115 and 125. However, it should be pointed out that the number of cascaded attenuators can be varied from two and up, so that the amount of attenuators shown in FIG. 1 is merely an example intended to illustrate a principle.

In the receiver system 100, the attenuators 105, 115 and 125 are controllable by a control signal to be active or not, i.e. to apply their attenuation or not to an input signal. As a general principle, one or more of the attenuators should be controllable in this manner. Also, in further embodiments, attenuators can be envisioned which are not merely controllable to be active/not active with respect to their attenuation, but in which the degree of attenuation can also be controlled by a control signal.

As shown in FIG. 1, the receiver system 100 also comprises a number of additional components, shown as 110, 120, and 130. These additional components are shown as being “interwoven” between the attenuators 105, 115 and 125, with one component 130 being located “after” the last attenuator 125 in the chain. The positions for and amounts of additional components are merely examples intended to illustrate a principle—the receiver system of the invention can comprise one or more such component between each of the attenuators and/or “after” the last attenuator in the chain, or the receiver system can comprise one or none of the additional components in the positions shown in FIG. 1. The additional components can be such components as, for example, filters, and are shown in FIG. 1 as having generic transfer functions h₁(n) to h₃(n).

The receiver system 100 comprises a first component 135 with a limited dynamic input range, for example an amplifier or an ADC, an analogue to digital converter, whose input signal must be kept within the limited dynamic input range. The component 135 is arranged to have as its input signal the output from the attenuator chain, and in the example shown in FIG. 1, the output from the receiver system 100 is the output signal from the component 135.

As mentioned previously, the input signal to the first component 135 must be kept within a certain limited dynamic range in order to avoid phenomena such as, for example, saturation. To this end, the receiver system 100 comprises a control loop 145 which is arranged to monitor the first component with respect to its input signal, to ensure that the input signal to the first component 135 is kept within the proper range. The monitoring can be done by, for example, measuring the level of the input signal to the first component 135, or, as an alternative, the control loop 145 can be arranged to measure the output signal from the first component 135, in order to thereby draw conclusions regarding the level of the input signal to the first component 135.

When monitoring the first component 135, the control loop 145 is arranged to determine which, if any, of the attenuators 105, 115, 125 to activate or deactivate in order to keep the signal from the attenuator chain to the first component 135 within the dynamic range of the first component. Attenuators are suitably controlled to be deactivated if it is desired to increase the level of the input signal to the first component 135, for example if the input signal is deemed to be too weak.

When the control loop 145 has determined which of the attenuators to activate or deactivate, the control loop is arranged to determine which of these attenuators that is located first in the attenuator chain, i.e. which of the attenuators that are to be activated that is the closest to the input of the attenuator chain. This attenuator will here be referred to as the “first attenuator”. It should be emphasized that the term “first attenuator” as used here does not necessarily have to refer to the attenuator which is located first in the attenuator chain in an absolute sense, i.e. the attenuator 105 in FIG. 1 does not always have to be the “first” attenuator—the control loop can, for example, decide to leave attenuator 105 as it is, and decide to control attenuators 115 and 125 to be active/inactive, in which case the attenuator 115 becomes the “first attenuator” in the sense of the term “first attenuator” as used here.

Once this attenuator, the “first” attenuator, is determined, the control loop 145 will activate or deactivate, according to the effect that it is desired to obtain on the input signal to the first component 135, any other attenuators which are located between the “first attenuator” and the first component 135 as the signal propagates to those attenuators through the attenuator chain from the “first” attenuator. As indicated in FIG. 1, each of the components which are arranged before the first component 135 has a propagation time, shown as t₁−t₆ in FIG. 1. If the control loop for example, decides that attenuators 105 and 125 should be activated, then attenuator 105 is first activated, i.e. it becomes the “first attenuator”, and then attenuator 125 is activated as the signal reaches it from the attenuator 105, i.e. at a point in time t₁+t₂+t₃+t₄ after the activation of attenuator 105. This is done in order to minimize the transient effects which arise when the attenuators are activated or deactivated.

The control loop 145 is connected to or comprises a compensation circuit 140 which is arranged to vary the level of the output signal of the first component 135. This can be done in a number of ways, for which reason the compensation circuit in FIG. 1 is shown “generically” as being connected to the first component 135. As an example, the compensation circuit 140 can be a controllable amplifier coupled in series with the first component 135. As another example, the compensation circuit 140 can be arranged to feed a control signal to the first component 135 which can be arranged to vary the level of its own output signal in this way.

As indicated in FIG. 1, the output signal of the first component 135 is in this example used as output signal of the receiver system 100, and since the control loop 145 can vary the attenuation of the input signal to the first component 135, and it is desired to keep the output signal from the receiver system as such constant, the control loop 145 is arranged to control the compensation circuit 140 to keep the level of the output signal from the first component 125 constant.

The compensation by the compensation circuit 140 is suitably initiated by the control loop 145 at a point in time when the attenuated signal starts to arrive at the first component from the point in time when the “first attenuator” has been controlled to be activated/deactivated, i.e. at t₁+t₂+t₃+t₄+t₅+t₆. Regarding the propagation times of the components 110, 120 and 130, the propagation times in these components can sometimes be so small compared to those of the attenuators that they can be ignored, as an alternative to being included in the sum t₁+t₂+t₃+t₄+t₅+t₆.

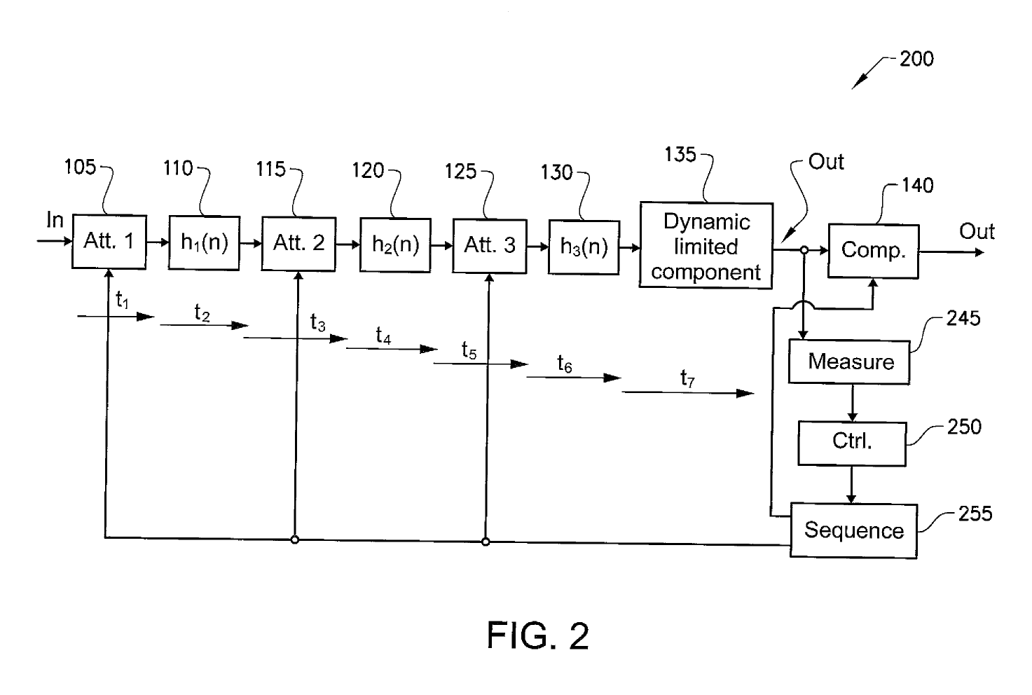

FIG. 2 shows a second and more detailed embodiment of a receiver system 200. In this embodiment, the control loop comprises a measuring circuit 245 for monitoring the first component 135 by means of measuring the level of the output signals from the first component 135—if the output signal reaches a certain level, a “saturation” level, it can be concluded that the input signal has exceeded the dynamic range of the first component 135.

The measuring circuit 245 is in turn connected to a control circuit 250 which is thus arranged to receive the measurements from the measuring circuit 245 and to use those measurements in order to determine which of the attenuators to activate or deactivate in order to keep the signal from the attenuator chain to the first component 135 within the dynamic range of the first component.

An example of how the control circuit 250 is arranged to function with respect to the control of the attenuators in the attenuator chain is as follows; the control circuit 250 receives a measurement of the output power level from the first component 135 at a level “A” from the measuring circuit 245. The control circuit 250 compares the level “A” with a known “saturation” value of the first component 135, which is suitably stored in a (not shown) memory unit, and determines that a reduction of B dB of the input signal to the first component is needed. This can also be seen as changing a state in an AGC system, i.e. altering the AGC's attenuation by reducing it with B dB.

The control circuit 250 compares the necessary reduction in input signal value with the attenuation given by the attenuators in the attenuator chain, and determines that a reduction of B dB can be obtained by activating attenuators 105 and 125, i.e. by controlling those attenuators to attenuate signals passing through them. The control circuit 250 is also provided with information, for example in a look up table in a (not shown) memory unit, of the propagation times for signals through each of the components in the receiver system, i.e. not only the attenuators 105, 115 and 125, but also, in the case of the receiver system shown in FIG. 1, the components 110, 120 and 130. These propagation times are shown in FIG. 1 as t₁−t₆. Since the attenuators 105 and 125 are those which are to be activated, the control circuit will first control the attenuator 105 to be active; it is thus the “first attenuator” in the sense of the term used above, i.e. the attenuator 105 is the first of the attenuators which are to be activated/deactivated which will receive a signal which is received by the receiver system 100.

The control circuit 150 will then control the attenuator 125 to be active with respect taken to the propagation times t₁+t₂+t₃+t₄, so that the attenuator 125 will be activated as the signal has propagated through components 105, 110, 115 and 120, i.e. at a point in time t₁+t₂+t₃+t₄ after the activation of attenuator 105. In this manner, the transients in the signal which are caused by the activation of the attenuators is minimized, as compared to, for example, activating both attenuators at the same time.

The activation sequence and the timing of the activation of the attenuators is, in this example, performed by a special sequencing circuit 255, which receives the activation times for the attenuators from the control circuit 250. Naturally, the sequencing circuit 255 can be an integrated part of the control circuit 250, or, as shown in FIG. 2, it can be a “stand alone” component.

Regarding the compensation circuit 140, in FIG. 2 it is shown as being connected in series with the first component 135, so that the output signal from the first component 135 is used as input signal to the compensation circuit 140. Thus, in this example, the output signal from the receiver system 100 is used as input to the compensation circuit 140, or, alternatively, this can be seen as using the output signal from the compensation circuit 140 as the output signal from the entire receiver system 100.

In addition to controlling the attenuators, the control circuit 250 is also arranged to, suitably together with the sequencing circuit 255, control the compensation given by the compensation circuit 140, so that the output signal from the receiver system 100 is as near constant as possible, which is done in the following manner: the signal which is attenuated by B dB by the two attenuators 105, 125, as shown above, will reach the compensation circuit 140 after propagating through the other components in the receiver system 100, including the first component 135, i.e. after a total propagation time of t₁+t₂+t₃+t₄+t₅+t₆+t₇. The control circuit 250 controls the sequencing circuit 255 to start an increase in the amplification given by the compensation circuit 140 by B dB at a point in time which is t₁+t₂+t₃+t₄+t₅+t₆+t₇ as seen from the time that the first attenuator 105 is activated. As an alternative, the compensation can be activated either at a later or at an earlier point in time, depending on system requirements.

Regarding the choice of which attenuators to activate in a case where more than one combination of activation or deactivation of attenuators will bring about the desired effect on the output signal to the first component 135, the combination of which attenuators to activate or deactivate can in principle be chosen arbitrarily, although different combinations may give the receiver system 100 as such different characteristics, which is used as a factor when choosing a certain combination of attenuators to activate or deactivate.

In the example shown previously, a principle was shown for choosing points in time to activate attenuators. If the opposite is desired, i.e. a decrease in attenuation is indicated by the value “A” as measured by the measuring circuit 245, and it is assumed, as an example, that attenuators 105 and 125 should be deactivated, as opposed to the example in which they were activated, the same principle as used in the case of their activation should be used: first, the attenuator 105 is deactivated, and then, at a point in time which is t₁+t₂+t₃+t₄ later, the attenuator 125 is deactivated. Similarly, the compensation in the compensation circuit is activated at a point in time which is t₁+t₂+t₃+t₄+t₅+t₆+t₇ later than the deactivation of attenuator 105. The deactivation of the attenuators 105 and 125 and the control of the compensation circuit 140 is carried out by the control circuit 250 together with the sequencer 255 as described previously.

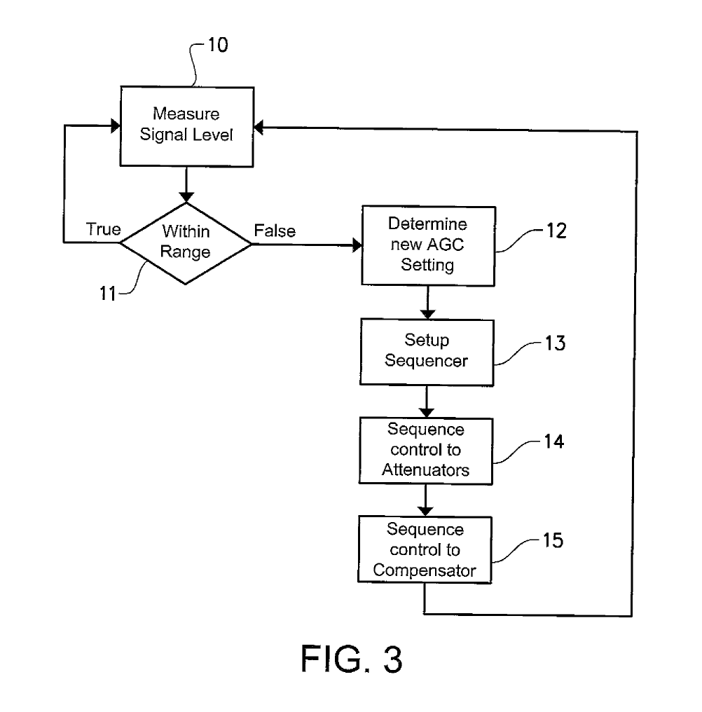

FIG. 3 shows a schematic block diagram 300 of a method used to control the attenuators and the compensator: As shown in step 10, the signal level at the output of the first component 135 is measured, and is then checked in step 11 in order to see if it is within the dynamic input range of the first component 135. If the signal level is within the dynamic input range, the procedure is repeated until the signal level is not within the dynamic input range of the first component 135. When the signal level is outside of the dynamic input range of the first component 135, a new AGC setting is determined in step 12, i.e. a new value for the attenuation given by the attenuation chain is determined.

In step 13, the sequencer 255 is set up to activate or deactivate the proper attenuators at the proper moments in time, keeping the propagation times in the attenuator chain in mind, and the same is done for the compensation circuit 140, i.e. a new compensation value is determined and a point in time is determined when the compensation level should be altered to this new value.

In step 14, the actual control signals are sent to the attenuators which are to be activated or deactivated, and in step 15, the same is done for the compensation circuit 140. The fact that the step of sending a control signal to the compensation circuit 140 is performed after the control signals to the attenuators illustrates the fact that the compensation circuit 140 is always last in the chain, i.e. the last circuit to have its settings altered. It can also be pointed out that the control signals to the attenuators are ON or OFF, since the attenuators used in the examples of FIGS. 1 and 2 are controlled to be activated or deactivated, whilst the control signal to the compensation circuit comprises a control to a different compensation value, which means that the control signal to the compensation circuit is not merely ON or OFF.

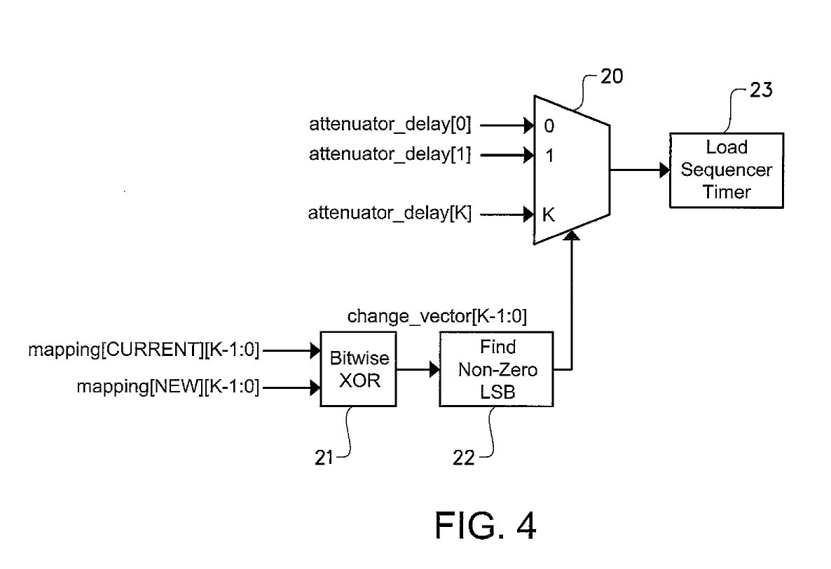

FIG. 4 shows a block diagram of a circuit which can be used in order to find the proper timing for the control signals to the attenuators in a case with K attenuators, where K is an integer larger than 2: the current settings of the attenuators are represented as a one dimensional vector with K−1 bits, if the first attenuator, i.e. the attenuator 105 in FIGS. 1 and 2, is seen as attenuator 0, and the attenuator which is last in the chain is seen as attenuator K. This vector is referred to as CURRENT [K−1:0] in FIG. 4.

Another one dimensional vector with K−1 bits, which represents the desired attenuator settings is referred to as NEW [K−1:0] in FIG. 4. The two vectors CURRENT [K−1:0] and NEW [K−1:0] are used as input to an XOR gate 21, which performs bitwise XOR on the two vectors, which produces a “change vector” of K−1 bits, i.e. a vector which indicates which attenuators that should have their states changed in order to obtain attenuator states which correspond to the desired vector NEW [K−1:0].

In order to find the attenuator in the attenuator chain which should be changed first, i.e. the attenuator which is first in the attenuator chain and whose state should be changed, the change vector is searched in block 22 for the least significant non-zero bit. The position of this bit in the change vector will correspond to the index (0 to K−1) of the attenuator which should be first to have its state altered.

The output of block 22, i.e. the index of the attenuator which should be first to have its state altered is used as input to block 20, in which the propagation delays of the attenuators in the attenuator chain are stored. The propagation delay from the attenuator which should be first to have its state altered to the first component 135 is used as input to a timer 23 for the sequencer 255 in FIG. 2.

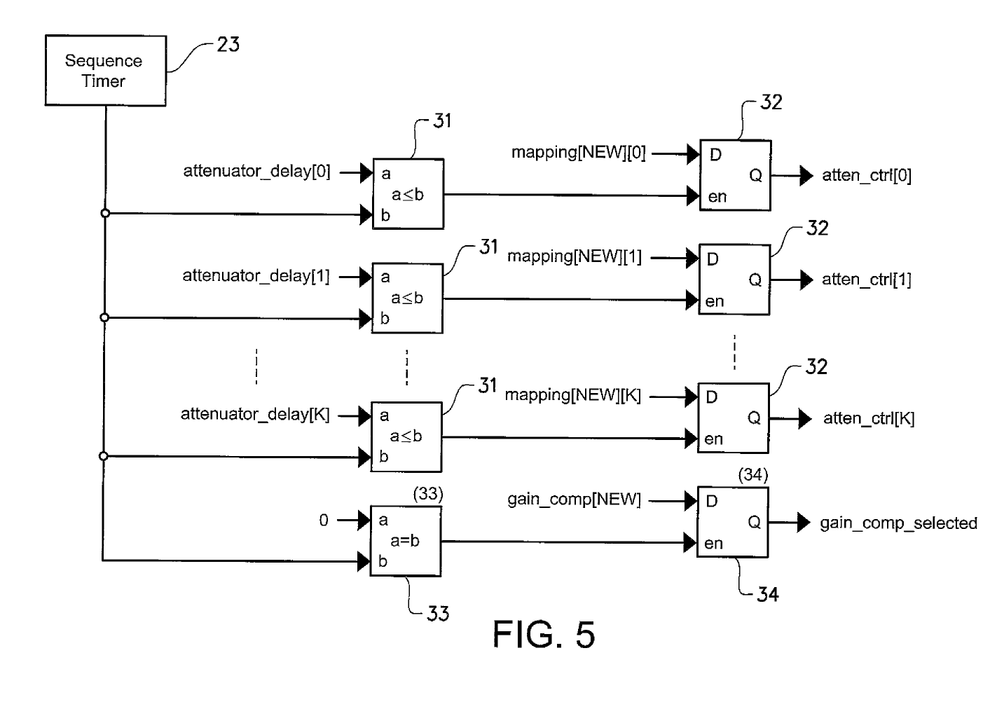

FIG. 5 shows an example of how the input to the timer 23 in FIG. 4 can be used by the sequencing circuit 255 for activation/deactivation of the attenuators and the compensation circuit:

When control signals are to be sent to the attenuators and the compensation circuit, corresponding to step 14 in the flow chart of FIG. 3, the sequence timer 23 initiates a countdown to zero. The value of the timer, shown as “a” in FIG. 5, is continuously sent to one comparator 31 for each attenuator, and one comparator for the compensation circuit. Each comparator also has as a second input signal “b” the propagation delay of its attenuator (or the compensation circuit). If the value of “b” exceeds or equals that of “a”, the comparator outputs a binary “1” to a so called “D Flip-Flop”, also known as a clocked shift register, one for each attenuator and one for the compensation circuit.

The component 32 uses the output signal from the comparator as an “enable” signal, and also has the value of “its” attenuator from the vector NEW in FIG. 4 as a second input signal. Thus, if the enable signal is “1” and the value of the attenuator in the NEW vector is also “1”, the attenuator receives a control signal which causes it to change its state. The same is true for the D Flip-Flop for the compensation circuit, with the difference that the output to the compensation circuit is a binary word comprising a plurality of bits, since the compensation circuit is to be controlled to have a new compensation value, not to be merely active or inactive.

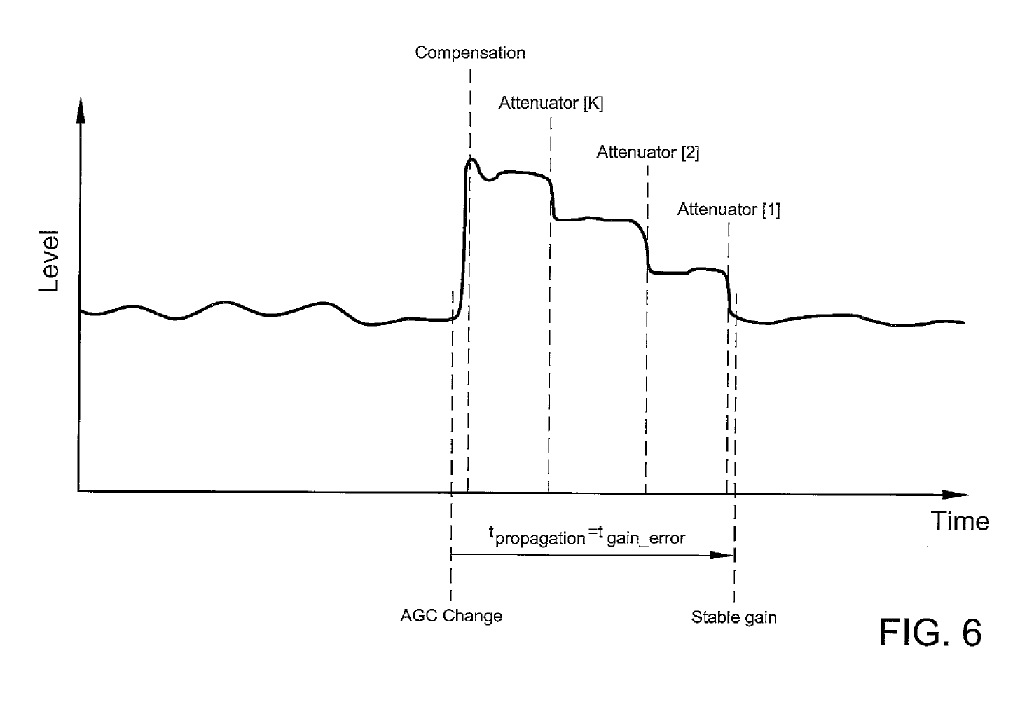

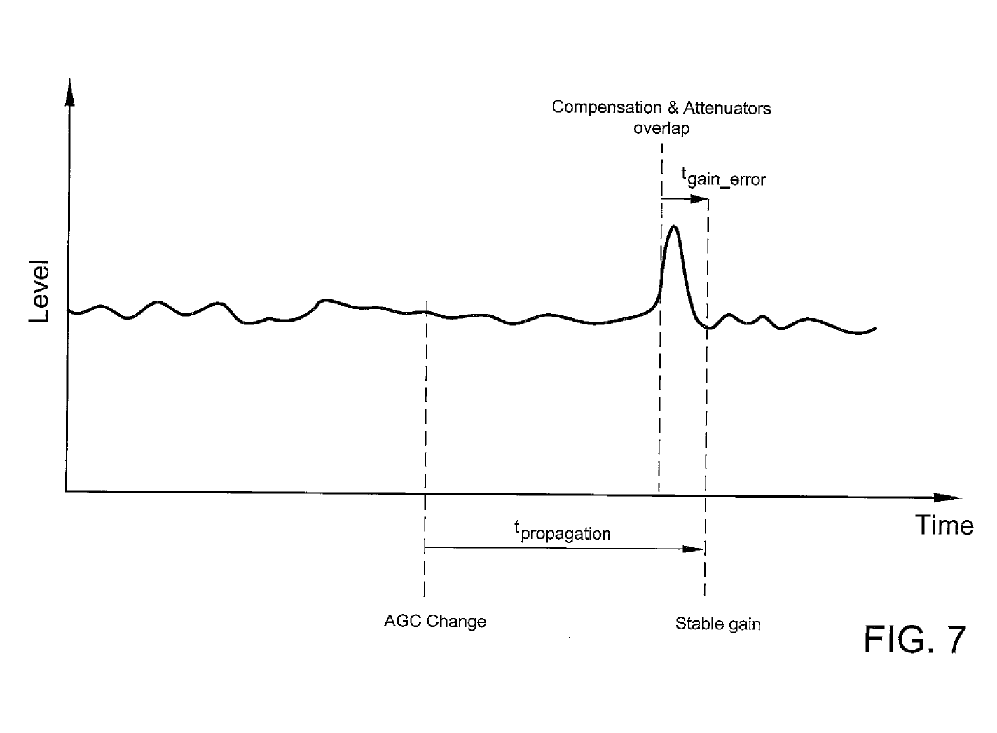

FIG. 6 shows the signal level as a function of time in a receiver system similar to that of FIG. 2, but in which all attenuators are activated simultaneously, i.e. a “prior art” system, and FIG. 7 shows the signal level as a function of time in the receiver system 200 of FIG. 2, i.e. a receiver system in which the invention is used. As can be seen, the signal level in FIG. 7 is much smoother than the one of the prior art system of FIG. 6.

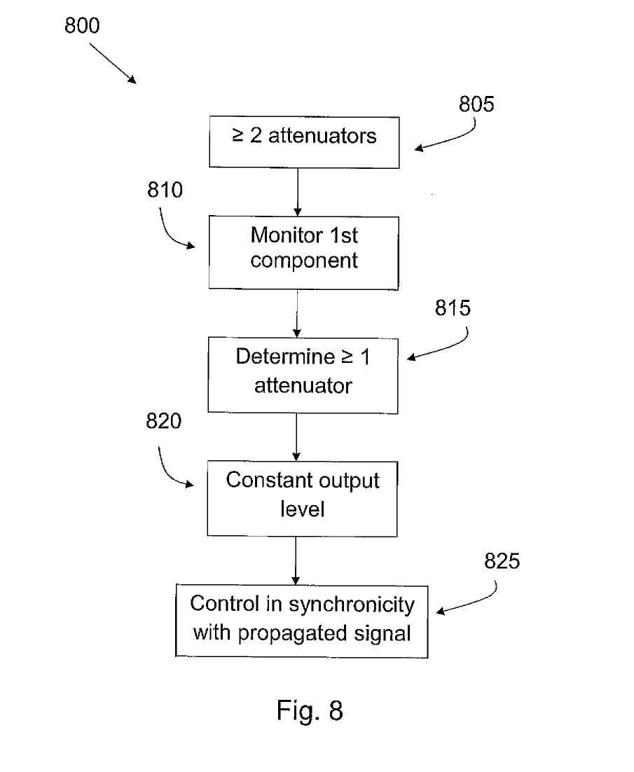

FIG. 8 shows a flow chart of a method 800 of the invention. The method is intended for use in a receiver system such as the one 100 of FIG. 1, and comprises, as indicated in step 805, arranging a chain of at least two attenuators, which are controllable with respect to their attenuation function, at the input to a first component which has a limited dynamic input range. As indicated in step 810, the method 800 also comprises monitoring 810 the input signal to the first component 135, and determining, step 815, at least one of said attenuators which should be controlled to be active or inactive in order to keep the input signal to the first component within the limited dynamic input range.

As shown in step 820, the method 800 also comprises controlling the level of the output signal from the first component to be constant, and as indicated in step 825, the method further comprises controlling the level of the output signal from the first component and any attenuators which are arranged between said at least one attenuator and the first component in synchronicity with the propagation of the signal from the at least one attenuator.

In some embodiments, the method 800 comprises arranging one or more additional components, each with its propagation delay time, in or in connection to the attenuator chain, and also comprises taking the propagation delay time of the one or more additional components into account in the control of the level of the output signal from the first component and of the attenuators which are arranged between the first component and the at least one attenuator.

In some embodiments, the method 800 comprises also taking into account a limited dynamic input range of the one or more additional components, and controlling one or more of the attenuators to be active or inactive in synchronicity with the propagation of the received signal from the at least one attenuator, so that the signal in or from the attenuator chain to the one or more additional components is within the dynamic input range of the one or more additional components.

In some embodiments of the method 800, the control of the level of the output signal from the first component is performed by means of a control signal to the first component, whilst in some embodiments, the control of the level of the output signal from the first component is performed by means of passing the output signal from the first component through a compensation circuit which is controlled by means of a control signal.

In the drawings and specification, there have been disclosed exemplary embodiments of the invention. However, many variations and modifications can be made to these embodiments without substantially departing from the principles of the present invention. Accordingly, although specific terms are employed, they are used in a generic and descriptive sense only and not for purposes of limitation.

The invention is not limited to the examples of embodiments described above and shown in the drawings, but may be freely varied within the scope of the appended claims.

1. A receiver system (100, 200) comprising an attenuator chain with at least two attenuators (105, 115, 125) coupled in cascade and arranged to attenuate a signal received by the receiver system, the attenuating function of one or more of said attenuators being controllable to be active or inactive, the receiver system also comprising a first component (135) with a limited dynamic input range, the first component being arranged to receive as its input signal the output signal from the attenuator chain, the receiver system also comprising a controllable compensation circuit (140) arranged to vary the level of the output signal of the first component, the receiver system being characterized in that it also comprises a control loop (145, 245, 250, 255) which is arranged to monitor the first component with respect to the level of its input signal and to control at least one of said attenuators (105, 115, 125) to be active or inactive so that the level of the input signal from the attenuator chain to the first component is within the dynamic input range of the first component and to control the compensation circuit (140) to keep the level of the output signal of the first circuit constant, with the control of the compensation circuit and of any attenuators which are arranged between the first component and said at least one attenuator being carried out in synchronicity with the propagation of the received signal through the attenuator chain (100) from said at least one attenuator.

2. The receiver system (100) of claim 1, comprising one or more additional components (110, 120, 130), each with its propagation delay time, the one or more additional components (110, 120, 130) being arranged in or in connection to the attenuator chain, with the control loop (145, 245, 250, 255) being arranged to take the propagation delay time of the one or more additional components (110, 120, 130) into account in the control of the compensation circuit and the attenuators which are arranged between the first component (135) and said at least one attenuator,

3. The receiver system (100) of claim 1 or 2, in which the one or more additional components (110, 120, 130) also have a limited dynamic input range and the control loop (145, 245, 250, 255) is arranged to control one or more of the attenuators (105, 115 125) to be active or inactive in synchronicity with the propagation of the received signal from the at least one attenuator through the attenuator chain (100), so that the signal in or from the attenuator chain to the one or more additional components (110, 120, 130) is within the dynamic input range of the one or more additional components (110, 120, 130).

4. The receiver system (100) of any of claims 1-3, in which the control loop comprises a measuring circuit (145) for obtaining measurement values of the output power of the first component (135), a control circuit (150) arranged to receive measurement values from the measuring circuit (145) and for determining which attenuator or attenuators to activate or deactivate in order to keep the signal from the attenuator chain to the first component (135) within the dynamic range of the first component and for controlling the compensation circuit (140) to keep the output power of the first component constant.

5. The receiver system (100) of any of claims 1-4, in which the controllable compensation circuit (140) is arranged to vary the level of the output signal from the first component (135) by means of a control signal to the first component (135).

6. The receiver system (100) of any of claims 1-4, in which the controllable compensation circuit (140) is arranged to vary the level of the output signal from the first component (135) by means of receiving the output signal of the first component as its input signal, and to vary said level by means of a control signal form the control loop (145, 255).

7. A method (800) for use in a receiver system (100), comprising (805) arranging a chain of at least two attenuators (105, 115, 125), which are controllable with respect to their attenuation function, at the input to a first component (135) which has a limited dynamic input range, the method (800) also comprising monitoring (810) the input signal to the first component (135) and determining (815) at least one of said attenuators which should be controlled to be active or inactive in order to keep the input signal to the first component (135) within said limited dynamic input range, the method (800) also comprising controlling (820) the level of the output signal from the first component (135) to be constant, the method (800) being characterized in that it comprises controlling the level of the output signal from the first component (135) and any attenuators which are arranged between said at least one attenuator and the first component (135) in synchronicity (825) with the propagation of the signal from said at least one attenuator.

8. The method (800) of claim 7, comprising arranging one or more additional components (110, 120, 130), each with its propagation delay time, in or in connection to the attenuator chain, comprising taking the propagation delay time of the one or more additional components (110, 120, 130) into account in the control of the level of the output signal from the first component and of the attenuators which are arranged between the first component (135) and said at least one attenuator.

9. The method (800) of claim 7 or 8, according to which the control also comprises taking into account a limited dynamic input range of the one or more additional components (110, 120, 130), and controlling one or more of the attenuators (105, 115 125) to be active or inactive in synchronicity with the propagation of the received signal from the at least one attenuator, so that the signal in or from the attenuator chain to the one or more additional components (110, 120, 130) is within the dynamic input range of the one or more additional components (110, 120, 130).

10. The method (800) of any of claims 7-9, according to which the control of the level of the output signal from the first component (135) is performed by means of a control signal to the first component (135).

11. The method (800) of any of claims 7-9, according to which the control of the level of the output signal from the first component (135) is performed by means of passing the output signal from the first component (135) through a compensation circuit which is controlled by means of a control signal.
